(19) United States
(12) Patent Application Publication
(10) Pub. No.: US 2025/0037095 A1
(43) Pub. Date: Jan. 30, 2025

(54) ELECTRONIC DEVICE AND METHOD FOR TRADING CONTENT

(71) Applicant: NCSOFT CORPORATION, Seoul (KR)

(72) Inventors: Jinseong HWANG, Seoul (KR); Yongseung LEE, Seoul (KR)

(73) Assignee: NCSOFT CORPORATION, Seoul (KR)

(21) Appl. No.: 18/912,079

(22) Filed: Oct. 10, 2024

Related U.S. Application Data
(63) Continuation of application No. PCT/KR2022/005313, filed on Apr. 12, 2022.

(51) Int. Cl. G06Q 20/06; A63F 13/792; G06Q 20/36

(52) U.S. Cl. CPC G06Q 20/06; G06Q 20/36; A63F 13/792

(57) ABSTRACT

An electronic device includes: a communication circuit; memory storing instructions; at least one processor operably coupled to the communication circuit and the memory, wherein the at least one processor, when executing the instructions, is configured to, issue non-fungible token (NFT) related to first content, receive, via the communication circuit, a request for a transaction of the first content based on a first virtual currency, based on the received request for the transaction, identify an electronic wallet to which the NFT is allocated, and based on the transaction, allocate a second virtual currency to the identified electronic wallet.

### CROSS-REFERENCE TO RELATED APPLICATION

This application is a by-pass continuation application of International Application No. PCT/KR2022/005313, filed on Apr. 12, 2022, in the Korean Intellectual Property Office, the disclosure of which is incorporated by reference herein its entirety.

### BACKGROUND

### 1. Field

The disclosure relates to an electronic device and a method for trading content.

### 2. Description of Related Art

A user of an application may configure various objects displayed through the application. For example, a user of an online game may configure a ‘player character’ (PC) used in the online game. After configuring the various objects in the application executed on a client device, the user may request a server to display the various objects configured in the application. Client devices may include a smartphone, a tablet computer, a desktop computer, a laptop computer, a game console, and the like.

A service in which an object displayed in an application may be configured by a user may be provided. The object configured by the user may be displayed and used in the application. The object configured by the user may be allocated to the user and may be used only by the user. Accordingly, a method for selling the object configured by the user to another user or purchasing the object configured by another user may be required.

The technical problems to be achieved in the disclosure are not limited to those described above, and other technical problems not mentioned herein will be clearly understood by those having ordinary knowledge in the art to which the disclosure belongs, from the following description.

### SUMMARY

According to an aspect of the disclosure, an electronic device includes: a communication circuit; memory storing instructions; at least one processor operably coupled to the communication circuit and the memory, wherein the at least one processor, when executing the instructions, is configured to, issue non-fungible token (NFT) related to first content, receive, via the communication circuit, a request for a transaction of the first content based on a first virtual currency, based on the received request for the transaction, identify an electronic wallet to which the NFT is allocated, and based on the transaction, allocate a second virtual currency to the identified electronic wallet.

According to an aspect of the disclosure, a method performed by an electronic device, includes: issuing non-fungible token (NFT) related to first content, receiving a request for a transaction of the first content based on a first virtual currency, based on receiving the request for the transaction, identifying an electronic wallet to which the NFT is allocated, using the NFT, and based on the transaction, allocating a second virtual currency to the identified electronic wallet.

According to an aspect of the disclosure, an electronic device includes: a communication circuit; memory for storing instructions; and at least one processor operably coupled to the communication circuit and the memory, wherein the at least one processor, when executing the instructions, is configured to, based on a user input related to a designated application, identify a first object, based on information for displaying the first object and information for displaying one or more second objects, obtain first similarities between the first object and the one or more second objects, and based on first content related to the first object and one or more second contents, obtain second similarities between the first content and the one or more second contents, and based on the first similarities and the second similarities, issue non-fungible token (NFT) related to the first content.

The effects that may be obtained from the disclosure are not limited to those described above, and any other effects not mentioned herein will be understood by those having ordinary knowledge in the art to which the disclosure belongs, from the following description.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram for describing an electronic device and a plurality of external electronic devices connected to the electronic device through a network, according to one or more embodiments;

FIG. 2 is a flowchart for describing an example of an operation of an electronic device according to one or more embodiments;

FIG. 3 illustrates an example of an operation of an electronic device according to one or more embodiments;

FIG. 4 illustrates an example of an operation of an electronic device according to one or more embodiments;

FIG. 5 illustrates an example of an operation of an electronic device according to one or more embodiments;

FIG. 6 illustrates an example of content issued as an NFT according to one or more embodiments;

FIG. 7 is a flowchart for describing an example of an operation of an electronic device according to one or more embodiments; and

FIG. 8 illustrates an example of an operation of an electronic device according to one or more embodiments.

### DETAILED DESCRIPTION

An electronic device (or an external electronic device) according to one or more embodiments disclosed in the disclosure may be a device of various types. For example, the electronic device may include a portable communication device (e.g., a smartphone), a computer device, a portable multimedia device, a portable medical device, a camera, a wearable device, a server, or home appliances. The electronic device (or the external electronic device) according to an embodiment of the disclosure is not limited to the above-described devices.

The one or more embodiments of the disclosure and terms used herein are not intended to limit the technical features described in the disclosure to specific embodiments, and should be understood to include various modifications, equivalents, or substitutes of the corresponding embodiment. In relation to the description of a drawing, a similar reference numeral may be used for a similar or related component. A singular form of a noun corresponding to an item may include one of the items or a plurality of the items unless a relevant context clearly indicates otherwise. In the disclosure, each of phrases such as “A or B”, “at least one of A and B”, “at least one of A or B”, “A, B or C”, “at least one of A, B and C”, or “at least one of A, B or C” may include any one of the items listed together in the corresponding phrase among the phrases, or all possible combination thereof. The terms such as “1st”, “2nd”, or “first” or “second” may be simply used to distinguish the corresponding component from another corresponding component, but does not limit the corresponding components from another aspect (e.g., importance or order). In case that a (e.g., first) component is referred to be “coupled” or “connected” to “functionally or communicatively” to another (e.g., second) component or is referred to be “coupled” or “connected” to another (e.g., second) component without this term, it means that any of the component may be connected to the other component directly (e.g., wired), wirelessly, or through a third component.

The term “module” used in the disclosure may include a unit implemented with hardware, software, firmware, or combinations thereof, and for example, may be used interchangeably with the term such as logic, logic block, component, or circuit, and the like. The module may be an integrally configured component or a minimum unit or a part thereof that performs one or more functions. For example, according to an embodiment, the module may be implemented in a form of an application-specific integrated circuit (ASIC).

The one or more embodiments of the disclosure may be implemented as the software (e.g., a program) including one or more instructions stored in a storage medium readable by a machine (e.g., an electronic device). For example, a processor of the machine (e.g., the electronic device) may call at least one of one or more instructions stored from the storage medium, and execute it. This makes it possible for the machine to be operated to perform at least one function according to the at least one called instruction. The one or more instructions may include a code generated by a compiler or a code that may be executed by an interpreter. The machine-readable storage medium may be provided in a form of a non-transitory storage medium. Here, ‘non-transitory’ only means that the storage medium is a device that is tangible and does not include a signal (e.g., electromagnetic waves), and this term does not distinguish between the case where data is stored semi-permanently in the storage medium and the case where data is stored temporarily in the storage medium.

According to an embodiment, a method according to the one or more embodiments disclosed in the disclosure may be provided by being included in a computer program product. The computer program product may be transacted between a seller and a buyer as a product. The computer program product may be distributed in the form of the machine-readable storage medium (e.g., a compact disc read only memory (CD-ROM)), or may be distributed (e.g., downloaded or uploaded) online through an application store (e.g., Play Store™ or App Store™) or directly between two user devices (e.g., smartphones). In the case of online distribution, at least some of a computer program product may be stored at least temporarily or generated temporarily on the machine-readable storage medium, such as a server of a manufacturer, a server of application store, or memory of a relay server.

According to the one or more embodiments, each component (e.g., a module or a program) of the above-described components may include a single or a plurality of entity. According to the one or more embodiments, one or more components or operations among the above-described components may be omitted, or one or more other components or operations may be added. Alternatively, or additionally, the plurality of components (e.g., the module or the program) may be integrated into one component. In this case, the integrated component may perform one or more functions of each component of the plurality of components identically or similarly to those performed by the corresponding component of the plurality of components prior to the integration. According to the one or more embodiments, the operations performed by the module, the program, or another component may be executed sequentially, in parallel, repetitively, or heuristically, or one or more of the operations may be executed in a different order, omitted, or one or more other operations may be added.

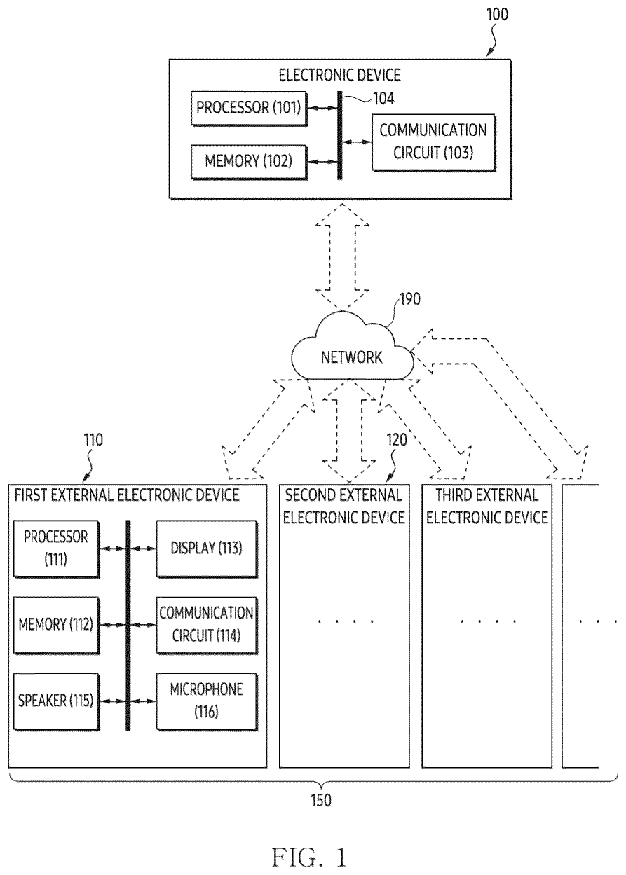

FIG. 1 is a block diagram for describing an electronic device and a plurality of external electronic devices connected to the electronic device through a network, according to one or more embodiments.

Referring to FIG. 1, an environment illustrated in FIG. 1 may include an electronic device 100, a plurality of external electronic devices 150, and a network 190. The electronic device 100 may be connected to the plurality of external electronic devices 150, based on a wired network and/or a wireless network.

For example, the wired network may include a network such as the Internet, a local area network (LAN), a wide area network (WAN), Ethernet, or a combination thereof. For example, the wireless network may include a network such as long term evolution (LTE), 5g new radio (NR), wireless fidelity (WiFi), Zigbee, near field communication (NFC), Bluetooth, Bluetooth low-energy (BLE), or a combination thereof.

FIG. 1 illustrates that the electronic device 100 is directly connected to the plurality of external electronic devices 150 through the network 190, but it is not limited thereto. For example, the electronic device 100 and the plurality of external electronic devices 150 may be indirectly connected through one or more routers and/or one or more access points (APs).

According to an embodiment, the electronic device 100 may include a server of a service provider. The electronic device 100 may include one or more personal computers (PCs) and/or a workstation. According to an embodiment, the electronic device 100 may calculate data generated as a plurality of characters corresponding to a plurality of users of the plurality of external electronic devices 150 act (e.g., moving, attacking, defending, and/or talking) in a virtual space (or metaverse). The electronic device 100 may provide a service (e.g., a game service) through an application (e.g., a game application) by transmitting the calculated data to the plurality of external electronic devices 150. For example, the electronic device 100 may calculate the data generated as a first character corresponding to a first user of a first external electronic device 110 among the plurality of external electronic devices 150 acts in the virtual space. The electronic device 100 may provide the service through the application by transmitting the calculated data to the first external electronic devices 110. The plurality of external electronic devices 150 may provide a screen for representing at least a portion of the virtual space to each of the plurality of users through the application, based on the data received from the electronic device 100. For example, the service provided by the electronic device 100 may be an online game. For example, the virtual space may be provided in the form of a picture and/or an image displayed in a three-dimensional coordinate system or a two-dimensional coordinate system on the screen of the first external electronic device 110, but is not limited thereto.

According to an embodiment, the electronic device 100 may be at least one server that provides the service for the application (e.g., the online game). For example, the electronic device 100 may include an application server, a charge processing server, a database that stores user information of the application, a database that stores data for executing the application, and a database that stores that data related to a payment transaction that is caused in the application. According to embodiments, the application server, the charge processing server, the database that stores the user information, the database that stores the data for executing the application, and the database that stores the data related to the payment transaction may also be implemented as a single physical machine or multiple physical machines.

According to an embodiment, the application server may process a calculation request related to the application received from the first external electronic device 110, which is a client device, based on linking to the database that stores the data for executing the application, and transmit information on the result of the process to the first external electronic device 110.

According to an embodiment, the application server may register the user of the first external electronic device 110, which is the client device, based on linking to the database that stores the user information of the application, or execute a user authentication, based at least on a relationship between account information received from the first external electronic device 110, and account information stored in the database that stores the user information.

According to an embodiment, the charge processing server may process the payment transaction caused during execution of the application, based on linking to the database that stores the data related to the payment transaction. In case that the payment transaction is related to account transfer or the credit card payment, the charge processing server may further link to the electronic device for a bank or a credit card company to process the payment transaction.

According to an embodiment, the electronic device 100 may include a processor 101, memory 102, and/or a communication circuit 103. According to an embodiment, the electronic device 100 may include at least one of the processor 101, the memory 102, and the communication circuit 103. For example, at least a portion of the processor 101, the memory 102, and the communication circuit 103 may be omitted according to an embodiment.

Throughout the disclosure, the processor 101 may indicate or correspond to one or more processors.

According to an embodiment, the processor 101 may be operably (or operatively) coupled with or connected with the memory 102 and the communication circuit 103. The processor 101, the memory 102, and/or the communication circuit 103 may be electronically and/or operably coupled with each other by a component such as a communication bus 104. For example, the processor 101 may control the memory 102 and the communication circuit 103. The memory 102 and the communication circuit 103 may be controlled by the processor 101.

Throughout the disclosure, the processor 101 may indicate or correspond to one or more processors. The one or more processors may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The one or more processors are able to perform control of any one or any combination of the other components of the computing device, and/or perform an operation or data processing relating to communication. The one or more processors execute one or more programs stored in a memory. The one or more processors may be implemented as one or more multi-core processors that include one or more cores (e.g., homogeneous multi-cores or heterogeneous multi-cores). When a plurality of cores are included in a processor, each of the cores includes a cache memory, and a common cache shared by the cores may be included in the processor. Each of the cores may independently read and execute program instructions or each of the cores may read and execute one or more portions of program instructions. In embodiments of the disclosure, a processor may refer to a system-on-a-chip (SoC) in which one or more cores and other electronic components are integrated, a single core processor, a multicore processor, or a core included in the single core processor or the multicore processor, wherein the core may be implemented as a CPU, a GPU, an APU, an MIC, an FPGA, a DSP, an NPU, a hardware accelerator, or a machine learning accelerator, but the embodiments of the disclosure are not limited thereto.

For example, according to an embodiment, the processor 101 may (be configured to) control at least one another component (e.g., a hardware or a software component) of the electronic device 100 connected to the processor 101 by executing the software, and may perform various data processing or the calculation. According to an embodiment, as at least the portion of the data processing or the calculation, the processor 101 may (be configured to) store the instruction or the data received from another component (e.g., the communication circuit 103) in the memory 102 (e.g., volatile memory), process the instruction or the data stored in the memory 102 (e.g., volatile memory), and store result data in the memory 102 (e.g., non-volatile memory). According to an embodiment, the processor 101 may include a main processor (e.g., a central processing unit or an application processor) or an auxiliary processor (e.g., a graphic processing unit, a neural processing unit (NPU), an image signal processor, a sensor hub processor, or a communication processor) that may be operated independently or together therewith.

According to an embodiment, the auxiliary processor (e.g., a neural network processing device) may include a hardware structure specialized for processing an artificial intelligence model. The artificial intelligence model may be generated through machine learning. For example, this learning may be performed in the electronic device 100 itself in which the artificial intelligence model is performed, or may also be performed through a separate server. For example, a learning algorithm may include supervised learning, unsupervised learning, semi-supervised learning, or reinforcement learning, but is not limited to the above-described example. The artificial intelligence model may include a plurality of artificial neural network layers. An artificial neural network may be one of a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-networks, or a combination of two or more of the above, but is not limited to the above-described example. The artificial intelligence model may additionally or generally include a software structure except the hardware structure.

The memory 102 may include the hardware component for storing the data and/or the instruction inputted to and/or outputted from the processor 101. For example, the memory 102 may include the volatile memory such as random-access memory (RAM) and/or the non-volatile memory such as read-only memory (ROM). For example, the volatile memory may include at least one of Dynamic RAM (DRAM), Static RAM (SRAM), Cache RAM, and Pseudo SRAM (PSRAM). For example, the non-volatile memory may include at least one of Programmable ROM (PROM), Erasable PROM (EPROM), Electrically Erasable PROM (EEPROM), flash memory, hard disk, compact disk, and embedded multimedia card (eMMC).

The communication circuit 103 may include the hardware component for supporting transmission and/or reception of an electrical signal between the electronic device 100 and the plurality of external electronic devices 150. For example, the communication circuit 103 may include at least one of a modem (MODEM), an antenna, and an optic/electronic (O/E) converter. The communication circuit 103 may support the transmission and/or reception of the electrical signal, based on a various type of protocol such as the Ethernet, the Local Area Network (LAN), the Wide Area Network (WAN), the Wireless Fidelity (WiFi), the Bluetooth, the Bluetooth Low Energy (BLE), the ZigBee, the Long Term Evolution (LTE), and the 5G New Radio (5G NR).

According to an embodiment, the plurality of external electronic devices 150 may be owned by different users. For example, the first external electronic device 110 may include a Personal Computer (PC) such as a laptop or a desktop and a smart accessory such as a smartphone, a smart pad, a tablet Personal Computer (PC), a smartwatch, and a Head-Mounted Device (HMD). Each of users using the plurality of external electronic devices 150 may be subscribers of the service provided by the electronic device 100.

According to an embodiment, the first external electronic device 110 among the plurality of external electronic devices 150 may include a processor 111, memory 112, a display 113, a communication circuit 114, a speaker 115, and/or a microphone 116. According to an embodiment, the first external electronic device 110 may include at least one of the processor 111, the memory 112, the display 113, the communication circuit 114, the speaker 115, and/or the microphone 116. For example, at least the portion of the processor 111, the memory 112, the display 113, the communication circuit 114, the speaker 115, and the microphone 116 may be omitted according to an embodiment.

According to an embodiment, the first external electronic device 110 may include the processor 1111. The processor 111 may be operably coupled or connected to the memory 112, the display 113, the communication circuit 114, the speaker 115, and the microphone 116. For example, the processor 111 may control the memory 112, the display 113, the communication circuit 114, the speaker 115, and the microphone 116. The memory 112, the display 113, the communication circuit 114, the speaker 115, and the microphone 116 may be controlled by the processor 111. The processor 111 may correspond to the processor 101 of the electronic device 100.

According to an embodiment, the first external electronic device 110 may include the memory 112. For example, the memory 112 may correspond to the memory 102 of the electronic device 100. According to an embodiment, the first external electronic device 110 may include the communication circuit 114. For example, the communication circuit 114 may correspond the communication circuit 103 of the electronic device 100.

According to an embodiment, the first external electronic device 110 may include the display 113. The display 113 may be used to output visualized information to the user. For example, the first external electronic device 110 may receive information for representing a screen corresponding to at least a portion of a virtual space that the electronic device 100 may provide. The first external electronic device 110 may display the screen corresponding to the at least a portion of the virtual space that may be provided by the electronic device 100 through the display 113, based on the received information.

According to an embodiment, the first external electronic device 110 may include the speaker 115. For example, the speaker 115 may output an acoustic signal so that the first external electronic device 110 may provide a voice notification to the user. For example, the number of speakers 115 included in the first external electronic device 110 may be one or more.

According to an embodiment, the first external electronic device 110 may include the microphone 116. For example, the microphone 116 may output an electrical signal corresponding to vibration of atmosphere. For example, the first external electronic device 110 may output an audio signal including a speech of the user, using the microphone 116.

In an embodiment, the first external electronic device 110 may include another output means for outputting information in a form other than a visual form and an audible form. For example, the first external electronic device 110 may include an actuator for providing haptic feedback based on the vibration.

According to an embodiment, each of the plurality of external electronic devices 150 (e.g., a second external electronic device 120) may include at least a portion or all of the component included in the first external electronic device 110. Each of the plurality of external electronic devices 150 may be independently configured by including the at least portion or all of the component included in the first external electronic device 110.

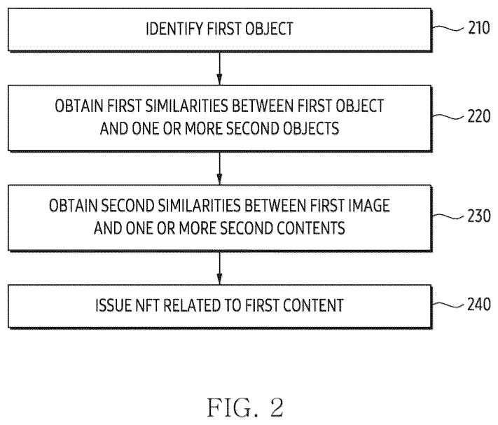

FIG. 2 describes an example of an operation of an electronic device according to one or more embodiments.

Referring to FIG. 2, in operation 210, a processor 101 may identify a first object. For example, the processor 101 may (be configured to) identify the first object, based on a user input related to a designated application.

According to an embodiment, the application designated in a first external electronic device 110 may be executed. The first external electronic device 110 (e.g., the processor 111 of the first external electronic device 110) may receive the user input in the designated application. For example, the user input may include an input for generating the first object. For example, the first object may be configured in three (3) dimensions. For another example, the user input may include an input for requesting that first content with respect to the first object be issued as an NFT.

According to an embodiment, the processor 101 of the electronic device 100 may provide the first external electronic device 110 with a platform for generating an object (e.g., the first object) through the designated application. For example, the processor 101 may (be configured to) provide the platform for generating the object, based on the user input in the designated application to the first external electronic device 110. The first external electronic device 110 may display the platform for generating the object to the user. The first external electronic device 110 may receive the input for generating the first object through the platform provided from the electronic device 100.

For example, the platform for generating an object through the designated application may mean the platform for generating the object related to a ‘player character’ (hereinafter “PC”) through an online game application. The first external electronic device 110 may display the platform for generating the object (e.g., the PC) related to the PC. The first external electronic device 110 may provide a tool for generating the object related to the PC. The tool for generating the object related to the PC may include the tool for designing the PC or a virtual item. For example, the first external electronic device 110 may provide various elements for generating the object related to the PC. For an example, the first external electronic device 110 may provide the various elements for generating a face of the PC. The first external electronic device 110 may provide various type of eyes, various type of face shapes, various type of noses, and/or various type of lips among faces of the PC. The user of the first external electronic device 110 may generate the face of the PC by combining the various provided elements. The first external electronic device 110 may provide a service for generating the object related to the PC to the user by providing the various elements for generating the object related to the PC through a display.

Although an embodiment of changing a form of the PC through the designated application is described above, the embodiment is not limited thereto. For example, the platform and/or the tool may include the platform and/or the tool for generating the virtual item personalized to the user by changing the form, color, and/or texture of the virtual item provided by the online game application. In the example, the object generated by the platform and/or the tool may be the virtual item. For another example, the platform and/or the tool may be the platform and/or the tool for changing a user interface (UI) (e.g., skin) of the online game application. In this case, as the object is processed by the online game application, at least a portion of the UI of the online game application may be deformed.

Although an embodiment in which the platform for generating the object through the designated application is related to the online game application is described above, the embodiment is not limited thereto. For example, the first object in operation 210 may be generated, based on the application that generates a document including text and/or an image, such as a word processor. For example, the first object in operation 210 may be generated, based on the application that generates an acoustic signal, such as a synthesizer. For example, the first object in operation 210 may be generated, based on a photo, a video, an illustration, and/or the application for producing the photo.

According to an embodiment, the first external electronic device 110 may generate the first object and display the generated first object in the designated application. For example, the first external electronic device 110 may generate the first object and transmit information on the generated first object to the electronic device 100. For an example, the information on the first object may include information for displaying the first object. The information for displaying the first object may mean a set of data for implementing the first object through a 3D screen.

According to an embodiment, the processor 101 of the electronic device 100 may receive the information on the first object generated from the first external electronic device 110. The processor 101 may identify the first object, based on the information on the first object. The processor 101 may transmit information for displaying a virtual space including the first object to the first external electronic device 110 through the display of the first external electronic device 110.

For an example, the first external electronic device 110 may display the platform for generating the form of the PC in the game application. The first external electronic device 110 may receive an input for generating a first PC (or the form of the first PC) from the user. The first external electronic device 110 may transmit information on the first PC and a request for displaying the first PC in the virtual space provided through the game application to the electronic device 100, based on the received input. The processor 101 of the electronic device 100 may receive the information on the first PC from the first external electronic device 110. The processor 101 may identify the first PC (or the form of the first PC). The processor 101 may transmit the information for displaying the virtual space including the first PC to the first external electronic device 110. The first external electronic device 110 may display the first PC and the virtual space including the first PC, based on the received information.

In operation 220, the processor 101 may (be configured to) obtain first similarities between the first object and one or more second objects. For example, the processor 101 may obtain the first similarities between the first object and the one or more second objects, based on the information for displaying the first object and information for displaying the one or more second objects.

For example, the one or more second objects may be a state generated from external electronic devices that are distinct from the first external electronic device 110. For example, the one or more second objects may be in a state generated by other users that are distinct from the user who generated the first object. The processor 101 may obtain the first similarities between the first object and the one or more second objects to identify whether the first object is the same or similar to the one or more second objects. For an example, the processor 101 may obtain the first similarity between the first object and the one or more second objects, based on the information for displaying the first object configured in three dimensions and the information for displaying the one or more second objects configured in three dimensions.

According to an embodiment, the processor 101 may obtain the first similarities between the first object and the one or more second objects by comparing the information for displaying the first object and the information for displaying the one or more second objects. For example, the processor 101 may obtain the first similarities between the first object and the one or more second objects by setting the information for displaying the first object and the information for displaying the one or more second objects as an input value of a similarity determiner configured with a first model indicated by a plurality of parameters related to a neural network. The first model may be indicated by the plurality of parameters related to the neural network. The first model may include a set of parameters related to the neural network. The neural network is a recognition model implemented with software or hardware that imitates a computational ability of a biological system using a large number of artificial neurons (or node). The neural network may perform a human cognitive action or a learning process through the artificial neurons. For example, the plurality of parameters related to the neural network may represent a plurality of nodes included in the neural network and/or weight assigned to a connection between the plurality of the nodes. For example, the processor 101 may obtain the first similarities between the first object and the one or more second objects, based on the similarity determiner.

For example, the processor 101 may obtain the first similarities between the first object and the one or more second objects, based on the similarity determiner configured with a designated algorithm that may be configured to compare the information for displaying the first object and the information for displaying the one or more second objects.

In operation 230, the processor 101 may obtain second similarities between the first content and one or more second contents. For example, the processor 101 may obtain the second similarities between the first content and the one or more second contents, based on the first content related to the first object and the one or more second contents.

According to an embodiment, the first content may be related to the first object. For example, the first content may be generated, based on the first object. For an example, the first object may be configured in three (3) dimensions. The first content may be configured in two (2) dimensions.

For example, the first external electronic device 110 may receive the user input for generating the first content. The first external electronic device 110 may receive the user input for generating first content, based on the first object. The first external electronic device 110 may generate the first content, based on the user input. The first external electronic device 110 may transmit information on the first content to the electronic device 100. The processor 101 of the electronic device 100 may identify the first content by receiving the information on the first content from the first external electronic device 110.

According to an embodiment, the one or more second contents may be a state generated from external electronic devices that are distinct from the first external electronic device 110. For example, the one or more second contents may be in the state generated by other users that are distinct from the user who generated the first content. The processor 101 may obtain the second similarities between the first content and the one or more second contents to identify whether the first content is the same or similar to the one or more second contents.

According to an embodiment, the processor 101 may obtain the second similarities between the first content and the one or more second contents through the similarity determiner. For example, the processor 101 may obtain the second similarities between the first content and the one or more second contents by setting the first content and the one or more second contents as an input value of the similarity determiner. For another example, the processor 101 may obtain (or identify) first feature points of the first content through a feature point extractor. The processor 101 may obtain second feature points of the one or more second contents through the feature point extractor. The processor 101 may obtain the second similarities between the first content and the one or more second contents by setting the first feature points and the second feature points as the input value of the similarity determiner.

For example, the processor 101 may obtain the second similarities between the first content and the one or more second contents, based on the similarity determiner configured with a second model distinct from the first model for obtaining the first similarity. The second model may be indicated by the plurality of parameters related to the neural network. The second model may include the set of parameters related to the neural network.

For example, the processor 101 may obtain the second similarities between the first content and the one or more second contents, based on the similarity determiner configured with the designated algorithm. For an example, the designated algorithm may be configured to compare the first content and the one or more second contents. For another example, the designated algorithm may be configured to compare the first feature points of the first content and the second feature points of the one or more second contents.

For example, the processor 101 may identify distance information between the first feature points and the second feature points, based on the designated algorithm. For example, the distance information may be obtained, based on a binary operation (e.g., a XOR operation) between the first feature points and the second feature points, which appear based on a binary number, such as Hamming distance. For another example, the distance information may include a distance between vectors corresponding to the first feature points and other vectors corresponding to each of the second feature points. The processor 101 may obtain the second similarities between the first content and the one or more second contents, based on the distance information between the first feature points and the second feature points. For an example, the designated algorithm may include a scale invariant feature transform (SIFT) algorithm and/or a speed-up robust features (SURP) algorithm.

In operation 240, the processor 101 may issue a NFT with respect to the first content. For example, the processor 101 may issue the NFT with respect to the first content, based on the first similarities and the second similarities.

According to an embodiment, the processor 101 may issue the NFT with respect to the first content, based on that the first similarities and the second similarities satisfy a designated condition. For example, the processor 101 may issue the NFT with respect to the first content, based on identifying that the first similarities and the second similarities are less than or equal to a designated value. For an example, each of the first similarity and the second similarity may be set between 0 and 1. The smaller value of the first similarity may indicate that the first object and the one or more second objects are not similar. The smaller value of the second similarity may indicate that the first content and the one or more second contents are not similar. For an example, the processor 101 may issue the NFT with respect to the first content, based on the value of the first similarities and the value of the second similarities being 0.2 or less.

According to an embodiment, the first content and the NFT with respect to the first content may be independently transacted. For example, the first content may be transacted in the designated application. The NFT with respect to the first content may be transacted in an application (e.g., an NFT exchange application) that is distinct from the designated application. According to an embodiment, the processor 101 may (be configured to) allocate a first virtual currency used in the designated application to a user account corresponding to the user who generated the first content, based on the first content being transacted in the designated application. In other words, the first content may be transacted, based on the first virtual currency. According to an embodiment, the NFT with respect to the first content may also be transacted in the designated application. In case that the NFT with respect to the first content is transacted in the designated application, the first content may also not be transacted in the designated application.

According to an embodiment, the processor 101 may (be configured to) identify an electronic wallet to which the NFT is allocated, based on the first content being transacted in the designated application. The processor 101 may allocate (or provide) a second virtual currency to the electronic wallet to which the NFT is allocated.

For example, the processor 101 may allocate the second virtual currency to the electronic wallet of the user (e.g., an individual or a corporation) who generated the first content, based on the first content being transacted in the designated application. For example, the processor 101 may allocate the first virtual currency to the user who generated the first content and allocate the second virtual currency to the electronic wallet of the user, based on the first content being transacted in the designated application. In other words, the processor 101 may (be configured to) provide a portion of a profit of the first content as the second virtual currency, separately from the profit of the first content.

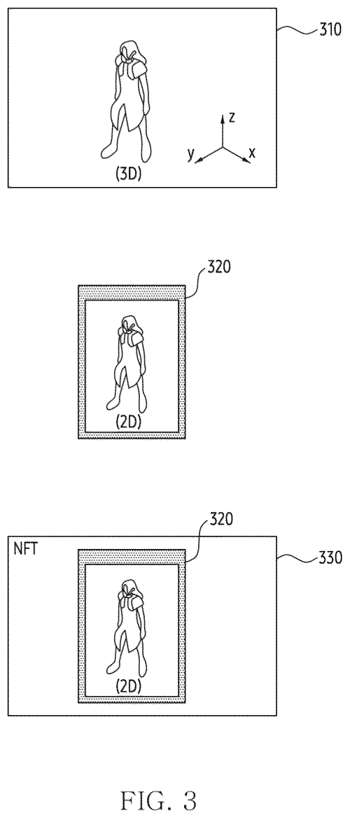

FIG. 3 illustrates an example of an operation of an electronic device according to one or more embodiments. Referring to FIG. 3, a processor 101 may identify a first object 310. The first object 310 may be generated based on a user input of a first external electronic device 110. The first object 310 may be generated through a platform for generating an object provided from an electronic device 100 to the first external electronic device 110. For example, the first object 310 may be configured in three (3) dimensions.

According to an embodiment, the processor 101 may (be configured to) receive information on the first object 310 from the first external electronic device 110. The information on the first object 310 may include information for displaying the first object 310. The processor 101 may receive the information on the first object 310. The processor 101 may identify the first object 310, based on the information on the first object 310.

According to an embodiment, first content 320 may be generated based on the first object 310. The first content 320 may be generated in the first external electronic device 110, based on the first object 310. The first external electronic device 110 may transmit information on the first content 320 to the electronic device 100. The processor 101 of the electronic device 100 may receive the information on the first content 320.

For example, the first content 320 may be configured in two (2) dimensions. The first content 320 may be generated through the first object 310 configured in three (3) dimensions. The first external electronic device 110 may receive a user input for generating the first content 320 through the first object 310. The first external electronic device 110 may generate the first content 320 through the first object 310, based on the received user input. The first external electronic device 110 may transmit the information on the first content 320 to the electronic device 100.

For example, the first content 320 may be configured with a screen, a video, and/or an image. For an example, the first content 320 may be an image in which the first object 310 configured in three (3) dimensions is generated in two (2) dimensions. For another example, the first content 320 may be a video in which the first object 310 configured in three (3) dimensions is displayed.

According to an embodiment, the first external electronic device 110 may embed information for restoring the first object 310 related to the first content 320 in metadata of the first content 320, which is a two (2)-dimensional image. For example, the information for displaying the first object 310 may be included in the metadata of the first content 320. The information for displaying the first object 310 may be included in the metadata of the first content 320, based on an exchangeable image file format (EXIF). For example, in case that the first content 320 is an image based on a joint photographic coding experts group (JPEG), a specific application for displaying the image may output the image based on the first content 320. In the example, in case of the designated application supporting generation and/or browsing of the first object 310, the designated application may output a three (3)-dimensional first object 310, based on the metadata of the first content 320 in a state of receiving the first content 320.

According to an embodiment, the first external electronic device 110 (e.g., the processor 111 of the first external electronic device 110) may receive the user input for requesting to issue the first content 320 with respect to the first object 310 as a NFT 330. The first external electronic device 110 may request the electronic device 100 to issue the first content 320 with respect to the first object 310 as the NFT 330. The processor 101 of the electronic device 100 may receive the request for issuing the NFT 330 with respect to the first content 320 from the first external electronic device 110.

According to an embodiment, the processor 101 may identify the information on the first object 310 and the information on the first content 320, based on the request for issuing the NFT 330 with respect to the first content 320 from the first external electronic device 110. In an embodiment, the processor 101 may identify first similarities between the first object 310 and one or more second objects. In an embodiment, the processor 101 may identify second similarities between the first content 320 and one or more second contents. In an embodiment, the processor 101 may issue the NFT 330 with respect to the first content 320, based on the first similarities and the second similarities.

For example, the processor 101 may identify that the first object 310 and the one or more second objects are not the same or similar. The processor 101 may identify that the first content 320 and the one or more second contents are not the same or similar. The processor 101 may identify that the one or more second objects generated through a plurality of other users other than the user who generated the first object 310 are not the same or similar. The processor 101 may identify that the one or more second contents generated through the plurality of other users other than the user who generated the first content 320 are not the same or similar. The processor 101 may issue the NFT 330 with respect to the first content 320, based on the fact that the first object 310 is not the same as or similar to the one or more second objects and that the first content 320 is not the same as or similar to the one or more second contents.

According to an embodiment, the NFT 330 may include the information on the first content 320. The NFT 330 may be used to represent the first content 320. The NFT 330 may be allocated to an electronic wallet of the user holding the NFT 330. According to an embodiment, the NFT 330 may include various information as well as the information on the first content 320. For example, the NFT 330 may include the information on the first object 310, the information on the first content 320, the information on the electronic wallet to which the NFT 330 is allocated, and/or information on a history to which the NFT 330 is allocated.

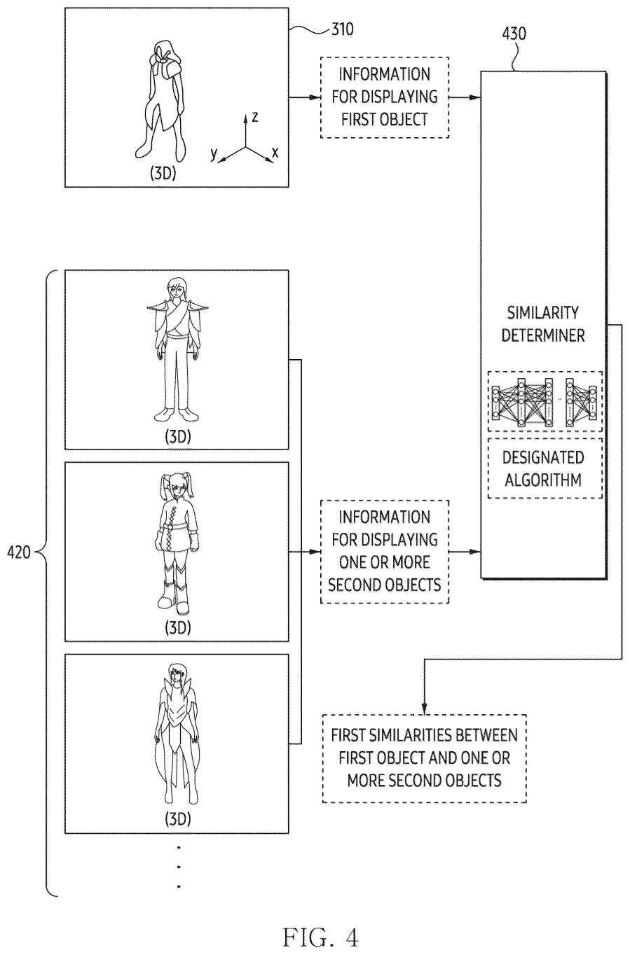

FIG. 4 illustrates an example of an operation of an electronic device according to one or more embodiments. Referring to FIG. 4, a processor 101 may identify a first object 310. For example, the processor 101 may identify the first object 310 generated based on a user input received from a first external electronic device 110. For example, the first object 310 may be configured in three (3) dimensions.

According to an embodiment, the processor 101 may identify whether the first object 310 and one or more second objects 420 are similar. The processor 101 may identify information for displaying the first object 310 and information for displaying the one or more second objects 420.

For example, the processor 101 may identify the information for displaying the first object 310, based on the first object 310. For another example, the processor 101 may receive the information for displaying the first object 310 from the first external electronic device 110. The information for displaying the first object 310 may include 3D modeling data for generating the first object 310 and/or 3D rendering data for generating the first object 310.

For example, the processor 101 may identify the information for displaying the one or more second objects, based the on the one or more second objects 420. For another example, the processor 101 may receive the information for displaying the one or more second objects 420 from one or more external electronic devices distinct from the first external electronic device 110. The information for displaying the one or more second objects 420 may include 3D modeling data for generating the one or more second objects 420 and/or 3D rendering data for generating the one or more second objects 420.

According to an embodiment, the processor 101 may obtain first similarities between the first object 310 and the one or more second objects 420 by using a similarity determiner 430.

For example, the processor 101 may obtain the first similarities between the first object 310 and the one or more second objects 420 by comparing the information for displaying the first object 310 and the information for displaying the one or more second objects 420. For example, the processor 101 may obtain the first similarities between the first object 310 and the one or more second objects 420 by setting the information for displaying the first object 310 and the information for displaying the one or more second objects 420 as an input value of the similarity determiner 430.

For example, the similarity determiner 430 may be configured with a first model indicated by a plurality of parameters related to a neural network. For an example, the processor 101 may set the information for displaying the first object 310 and the information for displaying the one or more second objects 420 as the input value of the first model. The processor 101 may obtain the first similarities between the first object 310 and the one or more second objects 420, based on the first model.

For another example, the similarity determiner 430 may be configured with a designated algorithm. The processor 101 may obtain the first similarities between the first object 310 and the one or more second objects 420 through the designated algorithm, based on the information for displaying the first object 310 and the information for displaying the one or more second objects 420. For an example, the processor 101 may identify feature points of the first object 310. The processor 101 may identify feature points of the one or more second objects 420. The processor 101 may obtain the first similarities between the first object 310 and the one or more second objects 420, based on identifying distance information between the feature points of the first object 310 and the feature points of the one or more second objects 420.

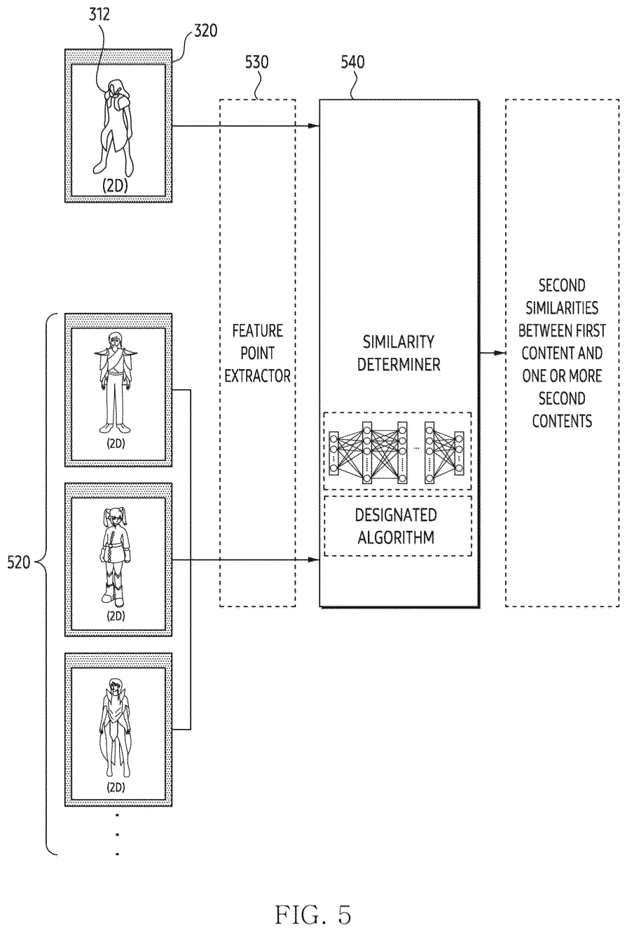

FIG. 5 illustrates an example of an operation of an electronic device according to one or more embodiments.

Referring to FIG. 5, a processor 101 may identify first content 320. For example, the processor 101 may identify the first content 320 generated based on a user input received from a first external electronic device 110. For example, the first content 320 may be configured in two (2) dimensions. For example, the first content 320 may be configured with a screen, a video, and/or an image. For an example, the first content 320 may be an image in which the first object 310 configured in three (3) dimensions is generated in two (2) dimensions. For another example, the first content 320 may be a video in which the first object 310 configured in three (3) dimensions is displayed.

According to an embodiment, the processor 101 may identify whether the first content 320 and one or more second contents 520 are similar. For example, the processor 101 may identify whether the first content 320 and the one or more second contents 520 are similar through a similarity determiner 540.

For example, the processor 101 may identify first feature points of the first content 320 through a feature point extractor 530. The processor 101 may identify second feature points of the one or more second contents 520 through the feature point extractor 530. For an example, the first feature points and/or the second feature points may include an edge, a corner, an image pattern, a color, a size, or an outline. The processor 101 may identify whether the first content 320 and the one or more second contents 520 are similar through the similarity determiner 540, based on the first feature points and the second feature points.

According to an embodiment, the processor 101 may obtain second similarities between the first content 320 and the one or more second contents 520 by using a similarity determiner 540 (or a similarity determiner 430 of FIG. 4).

For example, the processor 101 may obtain the second similarities between the first content 320 and the one or more second contents 520 by comparing information for displaying the first content 320 and information for displaying the one or more second contents 520. For example, the processor 101 may obtain the second similarities between the first content and the one or more second contents 520 by setting the first feature points of the first content 320 and the second feature points of the one or more second contents 520 as an input value of the similarity determiner 540.

For example, the similarity determiner 540 may be configured with a second model indicated by a plurality of parameters related to a neural network. For an example, the processor 101 may set the first feature points of the first content 320 and the second feature points of the one or more second contents 520 as the input value of the second model. The processor 101 may obtain the second similarities between the first content 320 and the one or more second contents 520, based on the second model.

For another example, the similarity determiner 540 may be configured with a designated algorithm. The processor 101 may obtain the second similarities between the first content 320 and the one or more second contents 520 through the designated algorithm. The processor 101 may obtain the second similarities between the first content 320 and the one or more second contents 520, based on identifying distance information between the first feature points of the first content 320 and the second feature points of the one or more second contents 520.

According to an embodiment, the processor 101 may obtain the second similarities between the first content 320 and the one or more second contents 520 without using the feature point extractor 530. For example, processor 101 may obtain the second similarities between the first content 320 and the one or more second contents 520 by setting the first content 320 and the one or more second contents 520 as the input value of the similarity determiner 540.

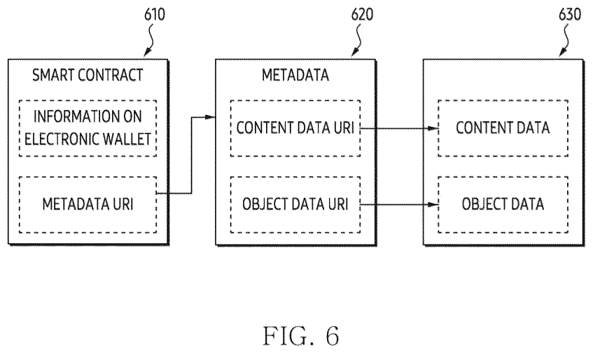

FIG. 6 illustrates an example of content issued as an NFT according to one or more embodiments.

Referring to FIG. 6, content (e.g., first content) may be set to a tradeable state by being issued (or minted) as the NFT. For example, the NFT may be configured based on an ERC-721 protocol. For another example, the NFT may be configured based on an ERC-1155 protocol. The above-described protocol is exemplary, and the NFT may be configured based on various other protocols as well as the ERC-721 and the ERC-1155 protocols.

According to an embodiment, the NFT may be configured with a plurality of parts. For an example, the NFT may be configured with three parts. The NFT may be configured with a first part 610, a second part 620, and a third part 630.

According to an embodiment, the first part 610 may be used for a smart contract. The first part 610 may include information on a contract between users. For example, the first part 610 may include information on an electronic wallet to which the NFT is assigned, and/or information on a Uniform Resource Identifier (URI) of metadata. In an embodiment, the first part 610 may further include information on a transaction record of the NFT or information on a record in which the NFT is temporarily allocated (or loaned). The first part 610 may be configured or stored based on a distributed ledger technology (or a blockchain).

According to an embodiment, the processor 101 may identify the metadata related to the content by identifying a metadata URI of the first part 610. According to an embodiment, the second part 620 may include information on the metadata. The metadata may include information on data related to the content. The metadata may include information on the URI of content data and/or information on an object data URI. According to an embodiment, the metadata may further include information for displaying an object (e.g., a first object).

The second part 620 may be configured or stored based on the distributed ledger technology (or the blockchain). According to an embodiment, the first part 610 and the second part 620 may be configured or stored based on different distributed ledger technology (or the blockchain). According to an embodiment, the second part 620 may be stored in a server for the metadata.

According to an embodiment, the third part 630 may include the content data and/or the object data. The content data and the object data may be configured or stored based on different distributed ledger technology. According to an embodiment, the content data and/or the object data may be stored in a separate server for storing the data. According to an embodiment, the content data and/or the object data may be stored in different server. For example, the content data may be stored in a first server. The object data may be stored in a second server.

According to an embodiment, the processor 101 of an electronic device 100 may identify information on the NFT. The processor 101 may identify the information on the NFT based on the first part 610 to the third part 630 of the NFT. For example, the processor 101 may identify the information stored in the first part 610 to the third part 630 of the NFT.

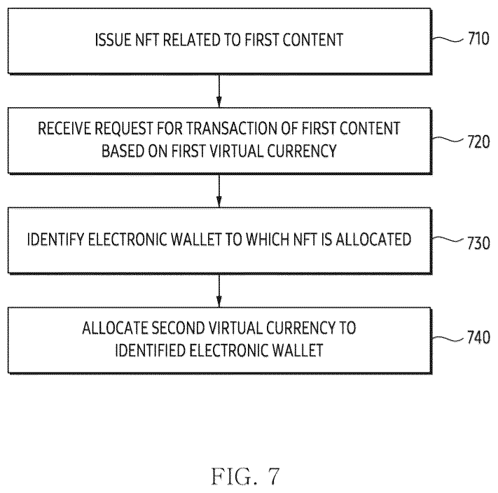

FIG. 7 is a flowchart for describing an example of an operation of an electronic device according to one or more embodiments.

Referring to FIG. 7, in operation 710, a processor 101 may issue an NFT related to first content. For example, the operation 710 may correspond to operation 240. For an example, the processor 101 may obtain similarities between the first content and one or more second contents. The processor 101 may issue the NFT, based on the similarities between the first content and the one or more second contents.

In operation 720, the processor 101 may receive a request for a transaction of the first content based on a first virtual currency. For example, the processor 101 may receive, via the communication circuit 103 of an electronic device 100, the request for the transaction of the first content based on the first virtual currency.

According to an embodiment, the first content may be transacted in a designated application (e.g., an online game application). In the designated application, the first virtual currency may be used for transaction of the first content.

According to an embodiment, independently of the first content, the NFT with respect to the first content may be transacted through an application (e.g., an NFT exchange application) distinct from the designated application. In the application distinct from the designated application, a second virtual currency may be used for transaction of the NFT with respect to the first content.

According to an embodiment, the processor 101 may receive the transaction request for selling the first content to another user from a first external electronic device 110 corresponding to a first account of a user who has generated the first content. For example, the processor 101 may receive a sales request for the first content based on the first virtual currency from the first external electronic device 110. The processor 101 may allocate, based on the received transaction request, the first content to a second account of the other user. Based on the received transaction request, the processor 101 may allocate a profit based on the first virtual currency to the first account. In other words, the processor 101 may change the first content allocated to the first account to be allocated to the second account. In addition, the processor 101 may allocate the profit based on the first virtual currency resulting from the sale of the first content to the first account.

In operation 730, the processor 101 may identify an electronic wallet to which the NFT is allocated. For example, the processor 101, based on receiving the request for the transaction, may identify the electronic wallet to which the NFT is allocated.

According to an embodiment, the electronic wallet to which the NFT is allocated may be related to the user who generates the first content. The processor 101 may identify the electronic wallet of the user who generated the first content by using the NFT related to the first content. For example, the processor 101 may identify the electronic wallet of the user who generated the first content by using the NFT related to the first content based on receiving the transaction request. For example, the transaction of the first content may be performed in the designated application. A sales profit of the first content may be allocated to the account of the user. The sales profit of the first content may be allocated to the first account of the user in the application distinct from the electronic wallet of the user. The processor 101 may allocate the profit based on the first virtual currency to the first account.

According to an embodiment, the NFT related to the first content may include information (e.g., information on an address of the electronic wallet) on the electronic wallet to which the NFT is allocated. The processor 101 may identify the electronic wallet of the user, using the NFT. For example, the electronic wallet may be used to allocate the NFT and the second virtual currency for transact the NFT.

According to an embodiment, the electronic wallet may also be used to allocate the first virtual currency for transacting the first content.

In operation 740, the processor 101 may allocate (or provide) the second virtual currency to the identified electronic wallet. For example, the processor 101, based on the transaction of the first content, may allocate the second virtual currency to the identified electronic wallet. For example, the processor 101 may provide the second virtual currency based on the transaction request to the user based on the identified electronic wallet.

According to an embodiment, the processor 101 may provide the second virtual currency based on a second transaction request to the user, independently of the transaction (or sales) profit of the first content. For example, the processor 101 may provide a portion of the profit based on the first virtual currency to the user through the second virtual currency.

According to an embodiment, the processor 101 may display a first object through a display of a second external electronic device 120. For example, the processor 101 may identify the NFT including information on the first object. For example, the information on the first object may include information for displaying the first object. The processor 101 may transmit, to the second external electronic device 120, the information for displaying the first object identified through the NFT. The second external electronic device 120 may display the first object through a display of the second external electronic device 120, based on the information for displaying the first object. The first object may be displayed through the display of the second external electronic device 120, based on the information for displaying the first object.

According to an embodiment, the processor 101 may also provide the first virtual currency based on the transaction request to the user (e.g., an individual or a corporation), based on the identified electronic wallet. For example, the processor 101 may provide the user with the profit from the transaction of the first content through the first virtual currency.

According to an embodiment, the processor 101 may discard the NFT related to the content that is the same as or similar to the first content. For example, the processor 101 may identify the first content and another NFT that is distinct from the NFT related to the first content. The processor 101 may identify a third content indicated by the other NFT. The processor 101 may identify similarity between the first content and the third content.

The processor 101 may identify whether the similarity between the first content and the third content satisfies a designated condition. The processor 101 may identify that the similarity between the first content and the third content satisfies the designated condition. For example, the processor 101 may identify whether a value of the similarity between the first content and the third content is less than or equal to a designated value. Based on identifying that the similarity between the first content and the third content satisfies the designated condition, the processor 101 may transmit information for indicating that the similarity between the first content and the third content satisfies the designated condition to the first external electronic device 110 corresponding to the user.

After transmitting the information for indicating that the similarity between the first content and the third content satisfies the designated condition to the first external electronic device 110, the processor 101 may identify time of issue of the NFT related to the first content and another NFT related to the third content. The processor 101 may discard the other NFT, based on the time of issue of the NFT related to the first content and the other NFT related to the third content. For example, the processor 101 may discard the other NFT, based on identifying that the time of issue of the NFT related to the first content is faster than the time of issue of the other NFT related to the third content.

According to an embodiment, the processor 101 may also receive the request for transferring ownership of the NFT from the first external electronic device 110 to another electronic wallet (e.g., the electronic wallet another user). The processor 101, based on the request for transferring ownership with respect to the NFT, may allocate the NFT to the other electronic wallet. After the NFT is allocated to the other electronic wallet, the processor 101 may allocate the profit based on usage of the NFT to the other electronic wallet. For example, the usage of the NFT may include allocating at least a portion of the first virtual currency and/or the second virtual currency exchanged in the transaction of the first content corresponding to the NFT to the other user related to another electronic wallet to which the NFT is allocated.

For example, a profit based on usage of the NFT may mean the first virtual currency or the second virtual currency obtained based on the transaction of the first content. The other user may be provided with the first virtual currency or the second virtual currency by allocating the first content to the account of the other user. In other words, the processor 101, based on the operation 710 to the operation 740, may allocate the profit based on the first virtual currency to the account of the other user who received the transfer of ownership of the NFT, and provide a portion of the profit based on the first virtual currency to the other user through the second virtual currency.

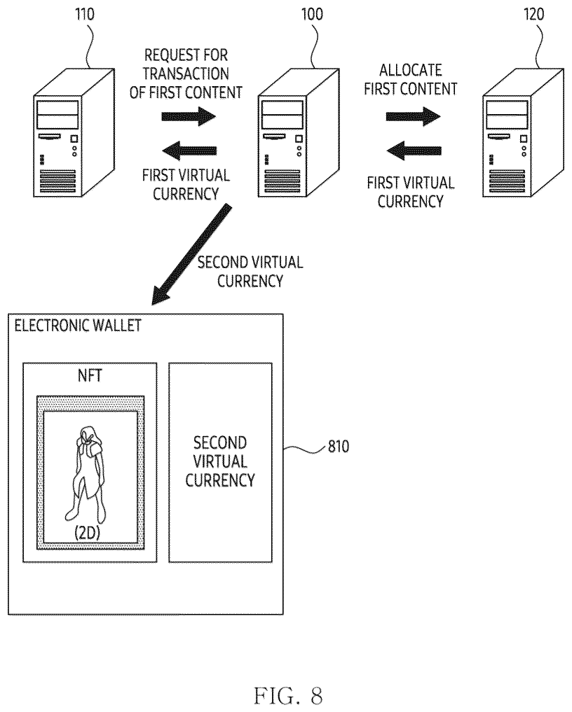

FIG. 8 illustrates an example of an operation of an electronic device according to one or more embodiments.

Referring to FIG. 8, a processor 101 of an electronic device 100 may broker a transaction of first content between a first external electronic device 110 and a second external electronic device 120. The first content may be allocated to a first account logged in to the first external electronic device 110. According to an embodiment, an NFT related to the first content may be allocated to an electronic wallet related to the first account. For example, the NFT related to the first content may be allocated to the electronic wallet of a user of the first account. The electronic wallet of the user may be used to store the NFT and a second virtual currency for transacting the NFT. For example, a first virtual currency may be used for the transaction in a designated application in which the first content is used. The second virtual currency may be used for the transaction of the NFT through an application distinct from the designated application. According to an embodiment, the second virtual currency may also be used in the designated application. The first virtual currency and the second virtual currency may also be used in the designated application.

According to an embodiment, the processor 101 of the electronic device 100 may receive a request for the transaction (or selling) of the first content from the first external electronic device 110. The processor 101 may receive a purchase request for the first content from the second external electronic device 120. The processor 101 may allocate the first content to a second account of the user of the second external electronic device 120. The second external electronic device 120 may transmit cost with respect to the first content to the electronic device 100 through the first virtual currency. The processor 101 of the electronic device 100 may receive the cost of the first content from the second external electronic device 120 through the first virtual currency. The processor 101 of the electronic device 100 may allocate the cost (or a profit for the first content) with respect to the first content to the first account of the user of the first external electronic device 110. According to an embodiment, the processor 101 may perform the transaction of the first content in the designated application. The first account and the second account may be an account logged in to the designated application.

According to an embodiment, a processor 101 may allocate (or provide) the second virtual currency to an electronic wallet 810, based on the transaction of the first content. For example, the processor 101 may provide the second virtual currency based on the transaction request of the first content to the user of the first external electronic device 110, based on the electronic wallet 810. For example, the processor 101 may allocate the second virtual currency to the electronic wallet 810. The processor 101 may additionally allocate the second virtual currency corresponding to at least a portion of a profit for the first content to the electronic wallet 810. The user of the first external electronic device 110 may be provided with both the first virtual currency and the second virtual currency, based on the transaction (or sale) of the first content.

According to one or more embodiments, an electronic device may include a communication circuit, memory for storing instructions, and at least one processor operably coupled to the communication circuit and the memory, and the at least one processor, when executing the instructions, may be configured to issue non-fungible token (NFT) related to the first content, receive, via the communication circuit, a request for a transaction of the first content based on a first virtual currency, identify an electronic wallet to which the NFT is allocated, using the NFT, based on receiving the request for the transaction, and allocate a second virtual currency to the identified electronic wallet, based on the transaction.

According to an embodiment, the at least one processor, when executing the instructions, may be configured to issue the NFT, based on similarities between the first content and one or more second contents.

According to an embodiment, the at least one processor, when executing the instructions, may be configured to, by inputting the first content and the one or more second contents to a model indicated by a plurality of parameters, stored in the memory, obtain the similarities between the first content and the one or more second contents from the model, and issue, based on the similarities between the first content and the one or more second contents, the NFT related to the first content.

According to an embodiment, the at least one processor, when executing the instructions, may be configured to obtain first feature points of the first content and second feature points of the one or more second contents, based on distance information between the first feature points and the second feature points, obtain the similarities between the first content and the one or more second contents, and issue, based on the similarities between the first content and the one or more second contents, the NFT.

According to an embodiment, the first content may be generated, based on a first object configured in three (3) dimensions through a first external electronic device corresponding to the user, and the at least one processor, when executing the instructions, may be configured to, based on information for displaying the first object and information for displaying one or more second objects, obtain the similarities between the first object and the one or more second objects, and to issue, based on the similarities between the first content and the one or more second contents, the NFT.

According to an embodiment, information for displaying the first object may be configured to be included in metadata of the NFT.

According to an embodiment, the at least one processor, when executing the instructions, may be configured to transmit, to a second external electronic device, the information for displaying the first object, identified through the NFT, and the first object may be displayed through a display of the second external electronic device based on the information for displaying the first object.

According to an embodiment, the at least one processor, when executing the instructions, may be configured to provide a platform for generating the object configured in three (3) dimensions to the first external electronic device.

According to an embodiment, the first content may be configured in two (2) dimensions in the platform based on the first object.

According to an embodiment, the first virtual currency may be used in a designated application for generating the first content, and the second virtual currency may be used except the designated application.

According to an embodiment, the at least one processor, when executing the instructions, may be further configured to receive a transaction request for selling the first content to another user from a first external electronic device corresponding to a first account of the user, allocate, based on the transaction request, the first content to a second account of the another user, and allocate a profit based on the first virtual currency to the first account.

According to an embodiment, the at least one processor, when executing the instructions, may be configured to receive a request for transferring ownership of the NFT from a first external electronic device corresponding to the user to an electronic wallet of another user, based on the request for transferring ownership of the NFT, allocate the NFT to the electronic wallet of the another user, and after the NFT is allocated to the electronic wallet of the another user, allocate a profit based on usage of the NFT to the electronic wallet of the another user.

According to an embodiment, a method of an electronic device may include issuing non-fungible token (NFT) related to first content, receiving, via the communication circuit of the electronic device, a request for a transaction of the first content based on a first virtual currency, based on receiving the request for the transaction, identifying an electronic wallet to which the NFT is allocated, by using the NFT, and based on the transaction, allocating a second virtual currency to the identified electronic wallet.

According to an embodiment, the issuing the NFT may include issuing the NFT, based on the similarities between the first content and one or more second contents.

According to an embodiment, the method may include, by inputting the first content and the one or more second contents to a model indicated by a plurality of parameters, stored in the memory, obtaining the similarities between the first content and the one or more second contents from the model, and issuing, based on the similarities between the first content and the one or more second contents, the NFT related to the first content.

According to an embodiment, the method may include obtaining first feature points of the first content and second feature points of the one or more second contents, based on distance information between the first feature points and the second feature points, obtaining the similarities between the first content and the one or more second contents, and issuing, based on the similarities between the first content and the one or more second contents, the NFT.

According to one or more embodiments, an electronic device may include a communication circuit, memory for storing instructions, and at least one processor operably coupled to the communication circuit and the memory, and the at least one processor, when executing the instructions, may be configured to issue non-fungible token (NFT) related to first content, receive, via the communication circuit, a request for a transaction of the first content based on a virtual currency, based on receiving the request for the transaction, identify an electronic wallet to which the NFT is allocated, and based on the transaction, allocate the virtual currency to the identified electronic wallet.

According to one or more embodiments, the electronic device may include a communication circuit, memory for storing instructions, and at least one processor operably coupled to the communication circuit and the memory, and the at least one processor, when executing the instructions, may be configured to, based on a user input related to a designated application, identify a first object, based on information for displaying the first object and information for displaying one or more second objects, obtain first similarities between the first object and the one or more second objects, based on the first content related to the first object and one or more second contents, obtain second similarities between the first content and the one or more second contents, and issue, based on the first similarities and the second similarities, the non-fungible token (NFT) related to the first content.

According to one or more embodiments, the at least one processor, when executing the instructions, may be configured to obtain, through a first model indicated by a plurality of parameters stored in the memory, the first similarities between the first object and the one or more second objects, and obtain, through a second model distinct from the first model, the second similarities between the first image and the one or more second contents.

According to an embodiment, the first object may be configured in three (3) dimensions, and the second object may be configured in two (2) dimensions.

Methods according to the embodiments described in claims or description of the disclosure may be implemented in a form of hardware, software, or a combination of the hardware and the software.

In case of being implemented as the software, a computer-readable storage medium storing one or more programs (software module) may be provided. One or more programs stored in the computer-readable storage medium are configured for execution by one or more processors in an electronic device. One or more programs include instructions that cause the electronic device to execute methods according to the embodiments described in the claims and the description of the disclosure.

One or more of these programs (software module, software) may be stored in random access memory, non-volatile memory including flash memory, read only memory (ROM), Electrically Erasable Programmable Read Only Memory (EEPROM), a magnetic disc storage device, an optical storage device (e.g., Compact Disk-ROM (CD-ROM)), a Digital Versatile Discs (DVDs), a magnetic cassette, or in memory configured with a combination thereof. In addition, it may be stored in the memory configured with a combination of a portion or all of these. In addition, the program may be stored in an attachable storage device that may be accessed through a communication network such as the Internet, an Intranet, a Local Area Network (LAN), a Wide LAN (WLAN), or Storage Area Network (SAN), or a communication network configured with a combination thereof. Such storage device may connect to the device performing an embodiment of the disclosure through an external port. In addition, the separate storage device on the communication network may be connected to the device performing an embodiment of the disclosure.

In the above-described specific embodiments of the disclosure, a component of the electronic device included in the disclosure have been expressed in singular or plural according to the presented specific embodiment. However, the singular or plural expression for the component are selected appropriately for the presented situation for convenience of description, and the disclosure is not limited to the singular or plural component, and even the component expressed in plural may be configured with the singular, or even the component expressed in singular may be configured with the plural.

In the detailed description of the disclosure, a specific embodiment has been described, but it goes without saying that a various modification is possible in the scope without departing from the scope of the disclosure. Therefore, the scope of the disclosure should not be limited to the described embodiment, but should be determined by those equivalents to the scope of this claim as well as the scope of the claims described below.

The embodiments may be described and illustrated in terms of blocks, as shown in the drawings, which carry out a described function or functions. These blocks, which may be referred to herein as the similarity determiner 430, the similarity determiner 540, the feature point extractor 530, or the like may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

What is claimed is:

1. An electronic device comprising:
a communication circuit;
memory storing instructions; and
at least one processor operably coupled to the communication circuit and the memory, wherein the at least one processor, when executing the instructions, is configured to:
issue non-fungible token (NFT) related to first content,
receive, via the communication circuit, a request for a transaction of the first content based on a first virtual currency,
based on the received request for the transaction, identify an electronic wallet to which the NFT is allocated, and
based on the transaction, allocate a second virtual currency to the identified electronic wallet.

2. The electronic device of claim 1, wherein the at least one processor, when executing the instructions, is further configured to, based on similarities between the first content and one or more second contents, issue the NFT.

3. The electronic device of claim 2, wherein the at least one processor, when executing the instructions, is further configured to:
by inputting the first content and the one or more second contents to a model indicated by a plurality of parameters, stored in the memory, obtain the similarities between the first content and the one or more second contents from the model, and
based on the similarities between the first content and the one or more second contents, issue the NFT.

4. The electronic device of claim 2, wherein the at least one processor, when executing the instructions, is further configured to:
obtain first feature points of the first content and second feature points of the one or more second contents,
based on distance information between the first feature points and the second feature points, obtain the similarities between the first content and the one or more second contents, and
based on the similarities between the first content and the one or more second contents, issue the NFT.

5. The electronic device of claim 2, wherein the first content is generated, based on a first object configured in three (3) dimensions through a first external electronic device corresponding to a user, and
wherein the at least one processor, when executing the instructions, is further configured to:
based on information for displaying the first object and information for displaying one or more second objects, obtain the similarities between the first object and the one or more second objects, and
based on the similarities between the first content and the one or more second contents, issue the NFT.

6. The electronic device of claim 5, wherein metadata of the NFT comprises information for displaying the first object.

7. The electronic device of claim 5, wherein the at least one processor, when executing the instructions, is further configured to:
transmit, to a second external electronic device, the information for displaying the first object, identified through the NFT, and
display the first object through a display of the second external electronic device, based on the information for displaying the first object.

8. The electronic device of claim 5, wherein the at least one processor, when executing the instructions, is further configured to provide a platform for generating the first object to the first electronic device.

9. The electronic device of claim 8, wherein the first content is configured in two (2) dimensions in the platform based on the first object.

10. The electronic device of claim 1, wherein the first virtual currency is used in a designated application for generating the first content, and
wherein the second virtual currency is used except the designated application.

11. The electronic device of claim 1, wherein the at least one processor, when executing the instructions, is further configured to:
receive a transaction request for selling the first content to another user from a first external electronic device corresponding to a first account of the user,
based on the transaction request, allocate the first content to a second account of the another user, and
allocate a profit based on the first virtual currency to the first account.

12. The electronic device of claim 1, wherein the at least one processor, when executing the instructions, is further configured to:
receive a request for transferring ownership of the NFT to another electronic wallet,
based on the request for transferring ownership of the NFT, allocate the NFT to the another wallet, and
after the NFT is allocated to the another wallet, allocate a profit based on usage of the NFT to the another wallet.

13. A method performed by an electronic device, the method comprising:
issuing non-fungible token (NFT) related to first content;
receiving a request for a transaction of the first content based on a first virtual currency;
based on receiving the request for the transaction, identifying an electronic wallet to which the NFT is allocated, using the NFT; and
based on the transaction, allocating a second virtual currency to the identified electronic wallet.

14. The method of claim 13, wherein the issuing the NFT comprises issuing the NFT, based on similarities between the first content and one or more second contents.

15. The method of claim 14, further comprising:
by inputting the first content and the one or more second contents to a model indicated by a plurality of parameters, stored in memory, obtaining the similarities between the first content and the one or more second contents from the model; and
based on the similarities between the first content and the one or more second contents, issuing the NFT related to the first content.

16. The method of claim 14, further comprising:
obtaining first feature points of the first content and second feature points of the one or more second contents;
based on distance information between the first feature points and the second feature points, obtaining the similarities between the first content and one or more second contents; and
based on the similarities between the first content and the one or more second contents, issuing the NFT.

17. The method of claim 13, wherein the second virtual currency corresponds to the first virtual currency.

18. An electronic device comprising:
a communication circuit;
memory for storing instructions; and
at least one processor operably coupled to the communication circuit and the memory, wherein the at least one processor, when executing the instructions, is configured to,
based on a user input related to a designated application, identify a first object,
based on information for displaying the first object and information for displaying one or more second objects, obtain first similarities between the first object and the one or more second objects, and
based on first content related to the first object and one or more second contents, obtain second similarities between the first content and the one or more second contents, and
based on the first similarities and the second similarities, issue non-fungible token (NFT) related to the first content.

19. The electronic device of claim 18, wherein the at least one processor, when executing the instructions, is further configured to:
obtain, through a first model indicated by a plurality of parameters, the first similarities between the first object and the one or more second objects, and
obtain, through a second model distinct from the first model, the second similarities between the first content and the one or more second contents.

20. The electronic device of claim 18, wherein the first object is configured in three (3) dimensions, and
wherein the first content is configured in two (2) dimensions.
